(19) United States
(12) Patent Application Publication
(10) Pub. No.: US 2009/0117918 A1
(43) Pub. Date: May 7, 2009

(54) Identification Method and System

(75) Inventors: Gunther Becker, Gottingen (DE); Bemt Sierke, Gottingen (DE)

Correspondence Address: JOYCE VON NATZMER;PEQUIGNOT + MYERS LLC, 200 Madison Avenue, Suite 1901, New York, NY, 10016, US

(73) Assignee: Knowledge Gesellschaft fur Wissenstransfer mbH, Berlin (DE)

(21) Appl. No.: 12/202,258

(22) Filed: Aug. 30, 2008

Related U.S. Application Data
(63) Continuation of application No. PCT/DE2007/001582, filed on Aug. 31, 2007.
(60) Provisional application No. 60/979,924, filed on Oct. 15, 2007.

(51) Int. Cl. H04W 4/02; G06F 7/00

(52) U.S. Cl. 455/456.3; 707/7; 707/E17.002

(57) ABSTRACT

The invention relates to a method and a system to compare a main profile of a first mobile telephone with at least one comparative profile of a second mobile telephone, wherein the profiles are transmittable via the mobile phones. The comparative profile is stored with individual user information for the second mobile phone and the main profile is created based upon the input of information of a user. By arranging the profile information into individual levels, it is possible, when making a comparison, to allocate to every level a level index for the correlation of the information. The combined level indices create an overall index, which is compared with a predetermined threshold. Exceeds the overall index, as degree of correlation between the profiles, the threshold, a contact establishment is enabled between the first and the second mobile phone and thus between the users. By means of the patent, a contact between two persons that are unknown to each other, can easily be established, wherein the contact establishment is initiated only between profiles with a predefined degree of correlation.

### CROSS-REFERENCE TO RELATED APPLICATIONS

This application is a continuation of International Application No. PCT/DE2007/001582, filed Aug. 31, 2007 and also claims the benefit of U.S. Provisional Application No. 60/979,924, filed Oct. 15, 2007. Both of these applications are incorporated herein by reference in their entiries.

### FIELD OF THE INVENTION

The invention is directed at a method and system to detect the correlation of user profiles of mobile telecommunication devices.

In particulat, the invention relates to a method and a system to compare a main profile of a first mobile telecommunication device with at least one comparative profile of a second mobile telecommunication device, wherein main and comparative profile are transmittable via the mobile telecommunication devices and wherein the retrievable comparative profile is deposited with individual information for the second mobile telecommunication device and the main profile is created by the entry of individual information by the user.

### BACKGROUND

Frequently, people are prevented, due to their education or due to social conventions, from establishing face-to-face contact with other people and thus from expressing their needs to fellow human beings. Therefore frequently, when wishing to establish first contact with somebody else, an electronical device, for example the world wide web, is used to achieve this in a partly anonymised manner.

Thus, the DE 103 45 443 A1 relates to a method to establish a connection for communication of a first telecommunication device via a communication network to a second telecommunication device. In this process, to begin with a plethora of multimedia devices that are allocated to a first telecommunication party, are saved in the telecommunication network along with a respective reference number. With establishment of a connection of the first telecommunication party to the second telecommunication device, the reference number will be identified and consequently, the telecommunication network enables transmission and playback of the respective multimedia device.

The DE 602 07 992 T2 relates to a method of a wireless communication-system and method for the generation of location-dependent information, in particular using GPS-data, wherein a person is informed that this person is close to a geographical position of an important event of information, of which the person has expressed an interest in and thus has ordered the informational service.

Related to this state of technique is another method for the electronic get-together of persons, according to DE 10 2005 052 323 A1, wherein location-dependent supply- and demand-profiles are saved as virtual ‘post its’, or ‘digital graffiti’ at a fix or mobile location, as specified by the user, via a mobile telecommunication device. Via a cellular mobile radio technique it is possible to determine the location of the inquiring party and the responding party and the automatic contacting of both parties can be initiated, in case of suiting demand and supply profiles.

Furthermore, the published patent application DE 10 2004 057 566 A1 states a method and system for establishing a contact, wherein by using mobile phones the users of mobile phones create at least one demand profile by input or choice of at least one parameter. The demand profile is sent out by the respective mobile phone and is compared with profiles compiled by means of different mobile phones. The users set a consistency rate for the correlation of the compared profiles, and the mobile phone of the party, with a matching consistency rate gives a signal. The invention as stated there enables to put a contacting network into effect.

Disadvantageous of momentary solutions of this state of technique is, that they do not directly publish a method for profile comparison of different profile information of the user. Particularly, there is no related method for the state of technique that uses the inserted information, where necessary with a user specific preference, for the comparison of user profiles, and thus when correlation is not hundred per cent, still allows for the initiation of the contact when there is a very close correlation of the profiles of the individual users.

A hundred percent correlation of profiles, as a result of identical profile information requires only small programming costs and is easily realised with known comparative operators. More complex comparative situations cannot be realised with known comparative methods, or are not known to the expert. Thus, DE 10 2004 057 565 A1 discloses the use of a consistency rate in the case of a non hundred per cent correlation of the compared profiles, but neither implicitly nor explicitly discloses a way to determine the considered consistency rate.

Aim of the invention is therefore, to provide a method for the determination of the correlation of user profiles, that is simple and fast in its procedure and yields a consistency rate that is verifiable.

The aim is solved by the criteria of the attached claims.

### SUMMARY OF THE INVENTION

The invention relates that a comparison takes place between the information that is hierarchically stored in the main and the comparative profile, wherein the comparison of the information corresponds to the respective hierarchic level and based on the respective hierarchical level a level index is allocated as a degree of correlation between the respective information of the respective hierarchical levels of the main and comparative profile. Subsequently, an overall index is generated, based on the level indices of the individual hierarchical levels as degree of correlation between the main and the comparative profile. Finally, a comparison is made of the overall index with a defined threshold for contact establishment, and in the case that the value of the overall index exceeds the defined threshold, the overall index as degree of correlation of the main profile with the comparative profile can be displayed to the first and second mobile telecommunication device. Through classification of the information into individual levels it is possible to conduct a profile comparison first of the respective hierarchical level and, subsequently, to generate an overall index as nominal value for a comparison with the defined threshold as minimal degree of correlation of the profiles. The levels may be assessed according to quality rating or priority for profile comparison for the generation of the overall index in view of their hierarchy.

For example, the information may be divided into four main categories with further subcategories. By clicking on or filling in a specified description field, the profile information is entered and the main profile is activated and access may be given by the user of the first mobile telecommunication device. Information for the main level may be personal information such as sex, age, type, zodiac sign, religious views, nationality, size, or hair colour. It might be indicated whether a picture of the user is available or whether the recipient is known by name. Furthermore, additional categories such as personal interests like sport or leisure time activities, personal views on love and relationship, cultural or educational interests might be chosen.

The user can adjust the favoured degree of correlation and/or the nature of the approved connection to the potential recipient, for instance, with regard to time, location or maximal amount of potential recipients. Furthermore, part of the comparative information of the user, for example sex, age and cultural interests may be alleged to be taken into stronger consideration during the comparison within the scope of the invention.

A mobile communication device according to the patent comprises all signal derived mobile devices, which enable an information—and/or voice reception and an information—and/or voice transmission, in particular mobile phones, PDAs, notebooks or handhelds.

In an advantageous configuration of the method it is intended, that the information is entered via a keyboard of the mobile telecommunication device and/or via a terminal, that might be connected to the mobile telecommunication device. Apart from the input via keyboard and limited display of the telecommunication devices, alternatively the data can be entered and forwarded independently of the telecommunication device via a separate terminal. In particular when using a mobile telecommunication device without, or with a limited keyboard, the external data input via a terminal is favourable.

In order that the user may individually control the distribution of the personal information, for every comparison of a main profile with the comparative profile, first the overall index is displayed to the first mobile telecommunication device, and only in case of approval by the first mobile telecommunication device, the overall index as degree of correlation is made available to the second mobile telecommunication device. Even in case of a high correlation rate, that exceeds the defined threshold, the user of the first telecommunication device determines, prior to the establishment of the contact, whether the personal information, or the request for contact establishment is dispatched.

In order to facilitate the input and to guide the user through data input the information will be entered for every hierarchical level in a standardised manner. In particular, the input in either predefined masks with defined description fields or the choice from pull-down-menus is an advantage of the patent. Additionally, the invention enables to assort the profile by choosing predetermined items from a data pool, for example, with the help of the cursor.

In an advantageous configuration of the method it is intended, that authentication of the user takes place before data input and/or before the transmission of the main profile via the first mobile telecommunication device and/or before transmission of the comparative profile via the second mobile telecommunication device. Authentication takes place, advantageously by means of entering a PIN (personal identification number) via the keyboard of the mobile telecommunication device or by scanning the fingerprints of the user by using a fingerprint scan that is integrated into the mobile telecommunication device.

The main profile and/or the comparative profile will be stored in a central database and/or in a local memory of the first mobile telecommunication device and/or in the local memory of the second mobile telecommunication device. Comparison of main and comparative profile can thus take place either centrally, through entry in a database, or—after prior transmission to one of the mobile telecommunication devices—directly in one of the mobile telecommunication devices.

For an improved storage and facilitated determination of relevant information, the information of the main and the comparative profile are stored as vector and/or matrix, wherein the respective vector position, or the respective row or column of the matrix corresponds to a respective hierarchical level. By engaging conventional algebraic operators, as commonly used in programming, the stored information is easily retrievable and can thus be used for comparison. So, for instance, the information can be allocated to the respective levels via a matrix, wherein the respective matrix value correlates with the weighting of the corresponding information. The level indices are weighted according to every hierarchical level and subsequently, combined in particular, added to create the overall index. Together with the realisation of a matrix diagram, the respective matrix values can be easily determined and be summed up algebraically—while taking into consideration the respective weightings. The combining of the level indices to an overall index can be realised by using known mathematical methods, so that apart from addition both integrals and/or, for instance, series expansion can be applied in terms of the patent.

When comparing several comparative profiles with the main profile, the overall-indices of the respective comparative profile are priorised according to the value of the respective overall indices. Are several comparative profiles available the method first chooses the overall indices with the highest value and evaluates the regional and/or temporal availability. In case that the overall index with the highest priority does not get the approval by the user, or in case that it might not be available, the successive overall index and thus the corresponding comparative profile are chosen for potential contact establishment.

In an advantageous configuration of the method it is intended, that the main profile information and/or the comparative profile information are compared by engaging adaptive systems, in particular neural networks and/or expert systems, and thus the degree of correlation can be detected according to the individual hierarchical level and/or according to the overall index and based on the previously determined preferences of the user. Based on the previously determined comparative results, the analysis of the user activity regarding the main profile and the behaviour of the user regarding the approval of or at the contact establishment, the behavioural patterns are analysed by means of adaptive systems. Thusly achieved behavioural patterns are taken into account by the adaptive system for the optimisation of the method. For instance, if a specific information of the comparative profile is frequently denied the approval, this can cause the downgrading of the weighting, and thus the importance of the specific information in the main profile of the user.

For comparison of profiles relating to a defined region it is considered, that the comparative profile of the second mobile telecommunication device can be received in a defined region, where in the main profile the maximal search radius is set around the location of the first mobile telecommunication device. When the locations correlate with the defined region, a comparison of the information of the main profile with the information of the comparative profile is initiated. Through this the comparison is constricted to position—or region—dependent mobile telecommunication devices, that are nearby, thus enabling fast contact establishment, in case of approval, between the nearby situated users of the mobile communication devices. This position—or region—dependence of the mobile telecommunication device for a comparison will be additionally combined with a temporal specification, for instance so that the contact is established at a defined location at specific times only.

The location of the first mobile telecommunication device and the defined region of the second mobile telecommunication device will be advantageously determined via a position determination of the first mobile telecommunication device and the second mobile telecommunication device within a telecommunication network. In particular, the cellular structure of the telecommunication network, for instance the radio cells in GSM or UMTS-network, serve to localise the telecommunication devices. The location of the first mobile telecommunication device and the defined region of the second mobile telecommunication device can additionally or alternatively be detected via a direct connection between the first mobile telecommunication device and the second mobile telecommunication device, in particular via Bluetooth-connection or radio contact.

In an advantageous configuration of the method it is intended, that the comparative profile of the second mobile telecommunication device is transferred into the local memory of the first mobile telecommunication device and will be compared via the comparative operator within the first mobile telecommunication device with the main profile, wherein the overall index and/or the comparative profile and/or a notification will be displayed to the first mobile telecommunication device. The use of the local memory of the first telecommunication device is advantageous as fast processing and thus fast comparison of the main profile with the comparative profile is enabled.

Transmission of the information via the telecommunication network is redundant in terms of the invention. The main profile of the first mobile telecommunication device and the comparative profile of the second mobile telecommunication device will alternatively be transmitted via the telecommunication network to a central database and will be compared centrally by a comparative operator, wherein the centrally determined overall index and/or the comparative profile and/or the notification is transmitted to the first mobile telecommunication device via the telecommunication network. This does not require further resources, such as memory capacity and/or computing time, of the mobile telecommunication device for the comparison of the profiles, as the determination of the overall-index and the comparison with the defined threshold takes place via a central available processing centre in the telecommunication network.

In order for the user to determine the transmission of the personal information and/or of the contact inquiry, it is intended, that after the transmission of the overall index and/or the comparative profile and/or the notification to the first mobile telecommunication device, the user of the first mobile telecommunication device is asked to approve of the contact establishment with the second mobile telecommunication device. Based on the obtained information the user is able to determine ultimately whether to establish the contact and can eventually, based on the previously obtained information, refrain from establishing contact. With the approval of contact establishment by the user of the first mobile telecommunication device, the overall index and/or the main profile and/or the notification will be transmitted to the second mobile telecommunication device.

In an advantageous configuration of the method it is intended, that at least one accessory mobile telecommunication device is allocated to the comparative profile, and in case of an approval of contact establishment the overall index and/or the main profile and/or the notification will be transmitted to both, the second mobile telecommunication device and the accessory mobile telecommunication device. This would, for example enable several users to organise a game of cards, when being short of players. The co-players allocate a comparative profile, and following the approval by the user who inquires to be admitted to the game of cards, the user informs concurrently all co-players via his corresponding main profile that a new co-player is found.

Advantageously, transmission of the overall index and/or the main profile and/or the notification is encrypted. The encoding is either based on a device, for example via an authentication module in form of a certificate, or programme based with known encrypting applications.

One aim of the invention is furthermore, to provide a system for a facilitated and fast comparison of user profiles.

This is aim is addressed by the characteristics of the system to compare a main profile of a first mobile telecommunication device with at least one comparative profile of a second mobile telecommunication device as set forth in the appended claims.

The invention intents, that a comparative operator makes a comparison of the information that is stored in the respective hierarchical level of the main and the comparative profile and the comparative operator allocates a level index, corresponding to the correlation of the data that is stored in the respective hierarchical level and, based on the level indices, creates an overall index, wherein the comparative operator makes a comparison of the overall index with a predetermined threshold for contact establishment and in the case that the value of the overall index exceeds the threshold, the dial-up manager transmits the overall index and/or the comparative profile and/or the notification to the first mobile telecommunication device.

In an advantageous configuration of the system it is intended, that the first mobile telecommunication device and the second mobile telecommunication device and an accessory telecommunication device can be connected via a telecommunication network.

Advantageously, the dial-up manager transfers the main profile and/or the comparative profile via the telecommunication network to a central database, and the comparative operator at a centrally available location within the telecommunication network compares the centrally stored information.

The first mobile telecommunication device and the second mobile telecommunication device and accessory telecommunication device are additionally or alternatively connectable via a direct connection, especially Bluetooth-connection or radio contact.

Alternatively to a central processing of profile comparison, it is intended, that the main profile and the comparative profile are transmitted to a local memory of the first mobile telecommunication device or the local memory of the second mobile telecommunication device, and that a comparison of the information takes place via the comparative operator in the second mobile telecommunication device.

In an advantageous configuration of the system it is intended, that after the approval of contact establishment by a user of a first mobile telecommunication device the dial-up manger in the telecommunication network and/or in the first mobile telecommunication device establishes a connection with the second mobile telecommunication device and/or the accessory mobile telecommunication device for the transmission of the overall index and/or the comparative profile and/or the notification. The activation time of the comparative operator can be adjusted by the user of the first mobile telecommunication device, thus allowing the comparison only in a time frame that is favoured by the user.

Advantageously, the comparative operator is an adaptive system, in particular a neural network and/or an expert system. By means of analysing previous user actions and the comparative results via the adaptive systems, the thusly retrieved user pattern can be used for optimisation of the processing. In particular, the determination of quality rating and priority of the levels can be adjusted based on previous user activity, without direct action by the user, by means of the adaptive systems.

Furthermore, the claim is solved by a computer programming product, wherein the computer programming product is stored in a medium that is computer readable, and comprises computer readable media, by which means a computer is caused to execute the method of the invention, when the programme is running in the computer.

Further advantageous configuration of the invention is solved by the claims.

The patent is hereafter described by the working example, wherein the patent is not restricted to the working example. Thereby, as exemplified in:

### BRIEF DESCRIPTION OF THE FIGURES

FIG. 1 flow chart of the method with a comparison of two levels, and

FIG. 2 presentation of the working sequence of the mobile telecommunication device together with the most important processing steps, and

FIG. 3 a UML-sequence diagram of the method with a dial-up manager and a comparative operator, and

FIG. 4 an input mask for choosing the profile information from a presented data pool.

### DESCRIPTION OF VARIOUS AND PREFERRED EMBODIMENTS

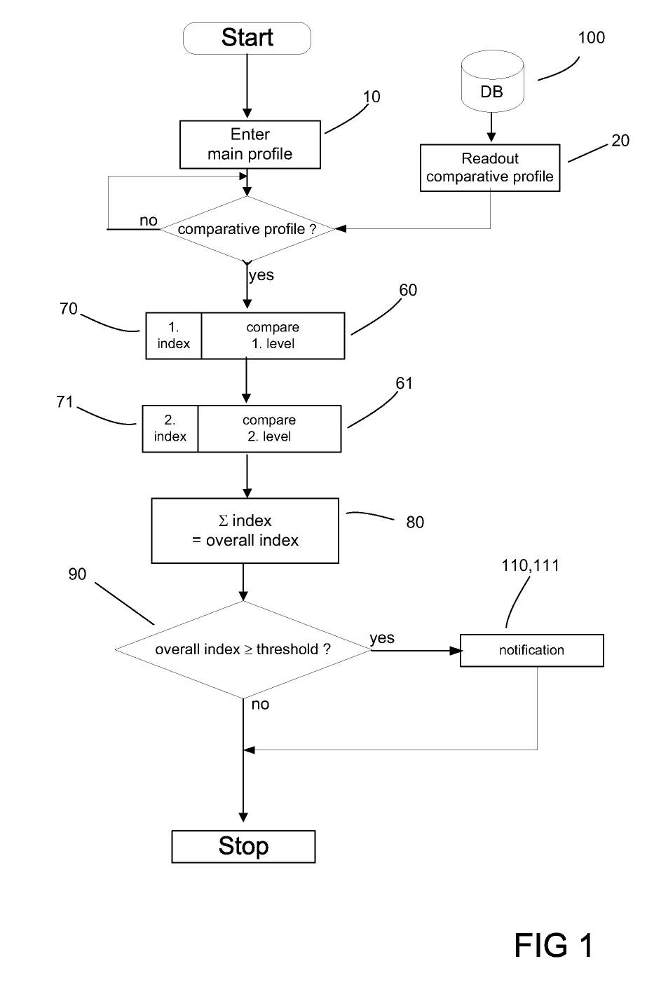

Figure FIG. 1 shows a flow chart of the method. After initiating the system, the user is asked to enter the main profile 10. The information 50 (not shown) is entered via description fields, for example via a keyboard of the first mobile telecommunication device 30 (not shown) or by choosing items from a presented data pool with the help of a touch screen display of the first mobile telecommunication device 30. Subsequently, the availability of the comparative profile 20 is determined. Is a comparative profile 20 lacking, the method remains in this status until a comparative profile 20 is available.

As exemplified in figure FIG. 1 the comparative profile 20 is stored along with the corresponding information 51 in the central database 100 and can be read out by the first mobile telecommunication device 30. A comparative operator 150 (not shown) compares the information 50, 51 for each level 60, 61 and allocates a level index 70,71 as a degree of the respective correlation. In figure FIG. 1 only two levels 60,61 are taken into consideration. The level indices 70, 71 are combined to an overall index 80. Subsequently, the overall index 80 is compared with a predefined threshold 90 for contact establishment. According to the working sequence as embodied in figure FIG. 1 no approval 130 by the user of the first mobile telecommunication device is requested, but in case that the overall index 80 as degree of correlation of the profiles 10, 20 exceeds the threshold 90, a notification 110,111 is at once sent out to the first mobile telecommunication device 30 and to the second mobile telecommunication device 40 (not shown).

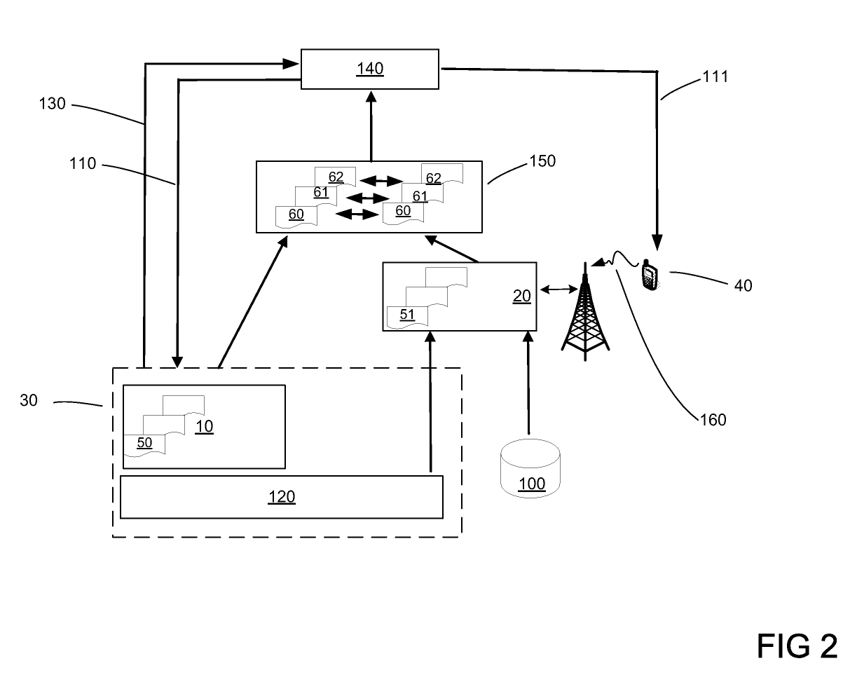

Figure FIG. 2 shows a schematic diagram of the mobile telecommunication device 30, 40 with the most important process steps. The first mobile telecommunication device 30 comprises a local memory 120 and a set of information 50 for a main profile 10. The information 50 of the main profile 10 is transmitted to the comparative operator. At the same time the information 51 of a comparative profile 20 are transmitted to the comparative operator 150. As exemplified in figure FIG. 2, three alternative transmission pathways for the information 51 are indicated. Either the information 51 of the comparative profile 20 can be transmitted directly from a second mobile telecommunication device 40 via a telecommunication network 160 to the comparative operator 150. Alternatively, the information 51 of the comparative profile 20 may be stored at a central database 100 and can be made available to the comparative operator 150. Furthermore, the information 51 of the comparative profile 20 may have already been transmitted to the local memory 120 of the first mobile telecommunication device 30 and from there will be made available to the comparative operator 150. The comparative operator 150 can either be integrated into or—as exemplified in figure FIG. 2—is part of a telecommunication network 150. The comparative operator 150 compares every level 60, 61, 62 of the hierarchically arranged information 50, 51 and allocates for every degree of correlation with a level, a level index 70, 71, 72 (not shown). The level indices are combined to an overall index 80 (not shown) and are compared with the predetermined threshold 90 (not shown). In case that the value of the overall index 80 exceeds the predetermined threshold 90, a dial-up manager 140 will be activated to establish a connection with the first mobile telecommunication device 30 and, subsequently, a notification 110 will be transmitted to the first mobile telecommunication device 30. The user of the first mobile telecommunication device 30 will be requested to approve of the transmission. As exemplified in figure FIG. 2 an approval (130) of contact establishment is issued and in return is transmitted to the dial-up manager 140. After receiving the approval 130, the dial-up manager 140 transmits a notification 111 to the second mobile telecommunication device 40.

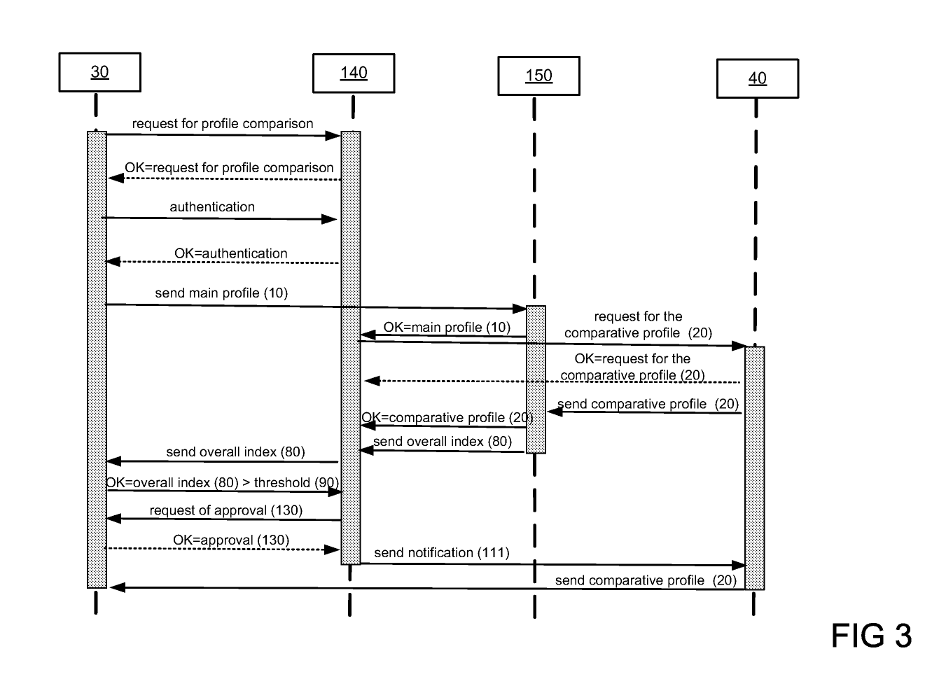

An UML (Unified Modelling Language)-sequence diagram of the procedure comprising a dial-up manger 140 and a comparative profile 150 is shown in figure FIG. 3. The first mobile telecommunication device 30 and the second mobile telecommunication device 40 are designated as only one respective object in the UML-sequence diagram. For clarity, the inherently necessary further objects for operating the first mobile telecommunication device 30 and the second mobile telecommunication device 40, in particular the agent for communication and data processing are not shown in the UML-sequence diagram.

The first mobile telecommunication device 30 starts a request for a comparison of the information 50 of the available main profile 10 (not shown) to the dial-up manager 140. The request is acknowledged by the dial-up manager 140 and after the response of the first mobile telecommunication device 30 the authentication process is initiated.

As exemplified in figure FIG. 3 the dial-up manager 140 has fast access to the deposited authentication and acknowledges the request with a positive feedback to the first mobile telecommunication device 30. Subsequently, the first mobile telecommunication device 30 transmits the main profile 10 with the corresponding information 50 to the comparative operator 150. The comparative operator 150 acknowledges the receipt of the main profile 10 to the dial-up manger 140, wherein subsequently, the dial-up manager 140 sends a request for the comparative profile 20 to the second mobile telecommunication device 40. The second mobile telecommunication device 40 acknowledges the request to the dial-up manager 140 and transmits the comparative profile 20 to the comparative operator 150. The comparative operator 150 acknowledges the receipt of the comparative profile 20 and conducts a level comparison 60, 61, 62 of the information (50, 51) of the main profile 10 and of the comparative profile 20.

By allocating a level index 70,71,72 for every comparison of the information 50,51, particularly taking into account quality rating of the respective levels 60,61,62 and/or the information 50,51 according to the respective levels 60,61,62, the comparative operator 150 creates an overall index 80, which is transmitted to the dial-up manager 140. Subsequently, the overall index 80 is transmitted to the first mobile telecommunication device 30 for further processing. In the first mobile telecommunication device 30 the predetermined threshold 90 is deposited and will be taken into account for the comparison with the overall index 80 within the first mobile telecommunication device 30. It is conveyed to the dial-up manager 140 that the overall index 80 exceeds the predetermined threshold 90, and thus a minimum of correlation exists between the main profile 10 and the comparative profile 20. The dial-up manager 140 subsequently initiates a request of approval 130 of contact establishment to the first mobile telecommunication device 30. On receipt of the approval 130 of contact establishment the dial-up manager 140 transmits, as exemplified in figure FIG. 3, to the second mobile telecommunication device 40 a notification 111. Thereupon, the first mobile telecommunication device 30 receives the complete comparative profile 20 for approval.

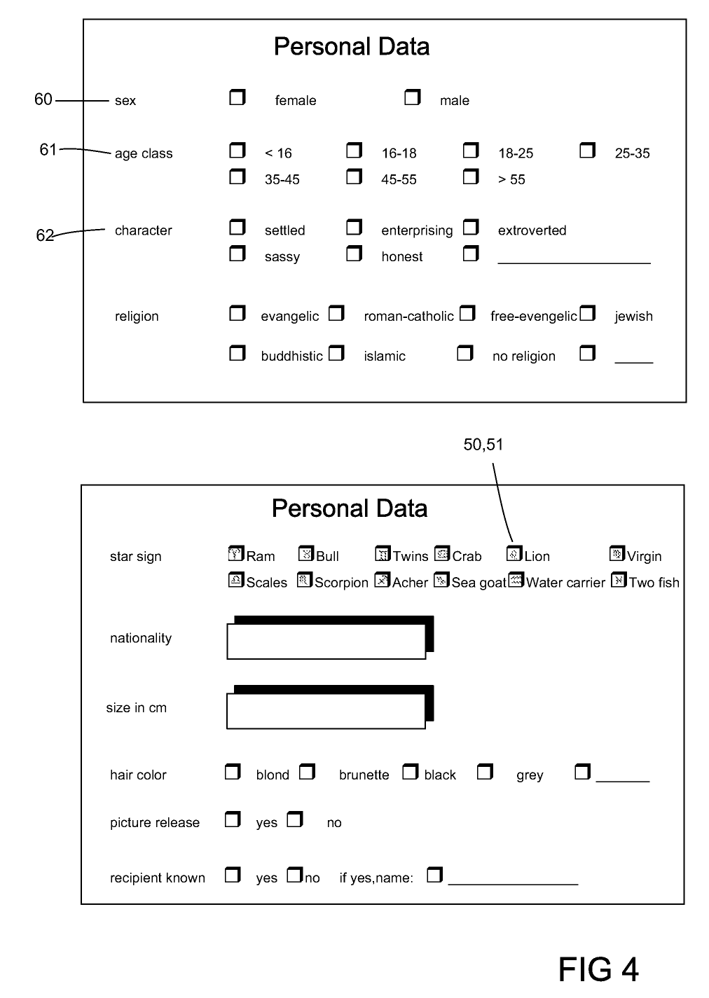

Figure FIG. 4 comprises an input mask for the selection of information 50, 51 for a main profile 10 (not shown) and/or the comparative profile 20 (not shown) from a predetermined data pool. The respective information 50, 51 are already hierarchically arranged and represent the levels 60, 61, 62, in terms of which a comparison of the main profile 10 and the comparative profile 20 is supposed to be conducted.

Depending on application and needs, the information 50, 51 of the respective level 60, 61, 62 may be varied and adjusted in regard to the menu options.

The patent aims to facilitate the establishment of contact between persons that have not met before, or are impaired in or have inhibitions to coming into direct contact with others. Thus, the patent might help in the following situation: A young man likes to go clubbing, he is a good dancer and is looking for some time now for a dancing partner for Latin American dances. Every single woman, he dared to ask today, whether she would like to dance with him, either rejects him, or is not interested in, least of all doesn't have the talent and motivation to do so. The young man, who is keen on dancing, wants to know whether there might be at least one young woman in the club, who also likes to engage in Latin American dances and who would indicate this in an unobtrusive manner that might not immediately be discernible to others.

Via the mobile communication devices 30,40, like mobile radio devices, it is possible by means of the patent to polarise and compare individual needs and contact interest. When the method discerns a multitude of correlating of matches, a contact is established between the users, for example via notification 110,111 in form of a newslet. Thereby, it is essential, that every user of a mobile telecommunication device 30,40, is able to enter personal preferences into different categories via a specially designed input interface; the user thus controls what is shared with others and he activates it for a certain amount of time and certain transmission radius as determined by himself. In case that a second mobile telecommunication device 40 is situated in the same radius which transmittable comparative profile 20 shows strong correlation to the individual preferences according to the own main profile 10 of the user of the first mobile telecommunication device 30, the method automatically, or after the approval by the user of the first mobile telecommunication device 30, establishes the contact via notification 110,111. Furthermore, instead of, or cumulatively, the overall index 80 and/or the respective unknown main profile 10 or comparative profile 20 can be transmitted to the mobile telecommunication devices 30,40. The method implements a ‘virtual small ad’, which only is obtained by the recipient, who displayed the same interests and made those accessible by entering personal preferences through the system. The access to the system may be used temporarily and can be adjusted to a different radius of reception; furthermore, every user of the first mobile telecommunication device 30 can limit the amount of potential recipients. Thus, the users are able, according to usecase and preference, to activate only certain parts of the main profile 10 or the comparative profile 20, to compare the respective interests. The following exemplifies a ‘virtual small ad’ as described: Female, 65 years, interested in theatre, coffeehouses, restaurants, cards is looking for: female, same age, radius 50 km, limited recipients: 30, temporary activation: 2 weeks. Activation and/or quality rating of the respective information 60,61,62 may vary regionally or temporarily as adjusted by the user.

### LIST OF REFERENCE NUMERALS

10 main profile
20 comparative profile
30 first mobile telecommunication device
40 second mobile telecommunication device
41 accessory mobile telecommunication device
50 profile information of main profile
51 profile information of comparative profile
60,61,62 hierarchical level of profile information
70,71,72 level index
80 overall index
90 threshold for contact establishment
100 central database
110 notification of the first mobile telecommunication device
111 notification of the second mobile telecommunication device
120 local memory
130 approval of contact establishment
140 dial-up manager
150 comparative operator
160 telecommunication network

1. Method for comparing a main profile of a first mobile telecommunication device with at least one other comparative profile of a second mobile telecommunication device, wherein the main profile and the at least one comparative profile are transmittable via the mobile telecommunication devices, the method comprising:
a.) storage of the comparative profile, which is retrievable, with individual information for the second mobile telecommunication device;
b.) creation of the main profile via input of individual information of a user;
c.) comparison of the individual information that are hierarchically arranged in the main profile and the comparative profile, wherein the comparison of the information is made corresponding to respective hierarchical levels and corresponding to a respective hierarchical level, a level index is allocated as degree of correlation between the respective information of the respective hierarchical level of the main profile and the comparative profile;
d.) creation of an overall index based on the level indices of the individual hierarchical levels as degree of correlation between the main profile and the comparative profile;
e.) comparison of the overall index with a defined threshold for establishment of contact, Wherein, if the value of the overall index exceeds the defined Threshold, the overall index can be made available to the first and the second mobile telecommunication device as degree of correlation between the main profile and the comparative profile.

2. Method of claim 1, wherein the information is entered via a keyboard of the mobile telecommunication devices and/or via a terminal that can be connected to the mobile telecommunication devices.

3. Method of claim 1, wherein the overall index is first displayed to the first mobile telecommunication device and only in case of approval by the first mobile telecommunication device, the overall index is shown to the second mobile telecommunication device as degree of correlation.

4. Method of claim 1, wherein the information is entered in a standardized manner for every hierarchical level.

5. Method of claim 1, wherein prior to input and/or prior to transmission of the main profile via the first mobile telecommunication device and/or prior to input and/or transmission of the comparative profile via the second mobile telecommunication device a user authentication takes place.

6. Method of claim 1, wherein the main profile and/or the comparative profile are stored in a central database and/or a local memory of the first mobile telecommunication device and/or a local memory of the second mobile telecommunication device.

7. The method of claim 6, wherein the information of the main profile and/or the information of the comparative profile are stored in form of a vector having a vector position and/or a matrix having rows and columns, wherein the respective vector position or the respective row and column of the matrix correspond to a respective hierarchical level.

8. The method of claim 1, wherein the level indices are weighted corresponding to every hierarchical level and subsequently are combined, in particular added, to form the overall index.

9. Method of claim 1, wherein when comparing several comparative profiles with the main profile the overall indices of the respective comparative profiles are prioritized corresponding to the values of the respective overall indices.

10. Method of claim 1, wherein the information of the main profile and/or the information of the comparative profile are compared via adaptive systems, in particular neural networks and/or expert systems, and thus the degree of correlation with regard to every hierarchical level and/or with regard to the overall index are determined based on previously determined preferences of the user.

11. Method of claim 1, wherein the comparative profile of the second mobile telecommunication device may be received in a defined region, wherein in the main profile a maximal search radius is allocated around a location of the first mobile telecommunication device and in case that the location correlates with a defined region a comparison of the information of the main profile is initiated.

12. Method of claim 11, wherein the location of the first mobile telecommunication device and a predetermined region of the second mobile telecommunication device is detected via determination of a position of the first mobile telecommunication device and the second mobile telecommunication device within a telecommunication network.

13. Method of claim 11, wherein the location of the first mobile telecommunication device and the defined region of the second mobile telecommunication device is detected via a direct connection between the first mobile telecommunication device and the second mobile telecommunication device, in particular via a Bluetooth-connection.

14. Method of claim 6, wherein the comparative profile of the second mobile telecommunication device is transferred to the local memory of the first mobile telecommunication device and, via a comparative operator within the first mobile telecommunication device, is compared with the main profile, wherein the overall index and/or the comparative profile and/or a notification are displayed to the first mobile telecommunication device.

15. Method of claim 6, wherein the main profile of the first mobile telecommunication device and the comparative profile of the second mobile telecommunication device is transferred to the central data-base via the telecommunication network and will be centrally compared via a comparative operator, wherein the overall index, which is centrally determined, and/or the comparative profile and/or the notification are transmitted to the first mobile telecommunication device via the telecommunication network.

16. The method of claim 15, wherein following the transmission of the overall index and/or the comparative profile and/or the notification to the first mobile telecommunication device, the user of the first mobile telecommunication device is requested to confirm the approval of the establishment of contact with the second mobile telecommunication device.

17. Method of claim 16, wherein the approval of the contact establishment by the user of the first mobile telecommunication device, the overall index and/or the main profile and/or a notification are transmitted to the second mobile telecommunication device.

18. Method of claim 15, wherein, at least one accessory mobile telecommunication device is allocated to the comparative profile and in the case of the approval of contact establishment, the overall index and/or the main profile and/or a notification are transmitted to both, the second mobile telecommunication device and to the accessory mobile telecommunication device.

19. Method of claim 15, wherein transmission of the overall index and/or main profile and/or notification is encrypted.

20. System to compare a main profile of a first mobile telecommunication device with at least one comparative profile of a second mobile telecommunication device, wherein the main profile and the comparative profile are transmittable via the mobile telecommunication devices, wherein that a comparative operator makes a comparison of the information that is stored in the respective hierarchical level of the main and the comparative profile and the comparative operator, corresponding to the correlation of information that is stored in the respective hierarchical level, allocates a level index, and based on the level indices, creates an overall index, wherein the comparative operator makes a comparison of the overall index with a predetermined threshold for contact establishment and in the case that the value of the overall index exceeds the defined threshold, a dialup manager transmits the overall index and/or the comparative profile and/or a notification to the first mobile telecommunication device.

21. System of claim 20, wherein the first mobile telecommunication device and the second mobile telecommunication device and an accessory mobile telecommunication device can be connected via a telecommunication network.

22. System of claim 21, wherein the dialup manager transfers the main profile and/or the comparative profile via the telecommunication network to a central database and a comparison of the information takes place via a comparative operator at a central location within the telecommunication network.

23. System of claim 21, wherein the first mobile telecommunication device and the second mobile telecommunication device and the accessory telecommunication device can be connected via a direct connection, in particular, via a Bluetooth-connection.

24. System of claim 20, wherein main profile and the comparative profile are transferred to a local memory of the first mobile telecommunication device to the local memory of the second mobile telecommunication device and a comparison of the information takes place via the comparative operator within the first mobile telecommunication device or via the comparative operator within the second mobile telecommunication device.

25. System of claim 20, wherein after approval of contact establishment by a user of a first mobile telecommunication device the dialup manager within the telecommunication network and/or within the first mobile telecommunication device establishes a connection with the second mobile telecommunication device and/or the accessory mobile telecommunication device for transmission of the overall index and/or the comparative profile and/or a notification.

26. System of claim 20, wherein an activation time of the comparative operator is adjustable by the user of the first mobile telecommunication device.

27. System of claim 20, wherein the comparative operator is an adaptive system, in particular a neural network and/or expert system.

28. System of claim 20 executed by a media for realization of the method according to claim 1.

29. Computer program product that is stored in a medium that is computer readable and comprises computer readable media, by which a computer is caused to conduct a method according to claim 1, while the computer program is running.
